(19) United States
(12) Patent Application Publication
(10) Pub. No.: US 2010/0196703 A1
(43) Pub. Date: Aug. 5, 2010

(54) ADHESIVE SHEET

(76) Inventors: Yoshitsugu Matsuura, Ibaraki (JP); Kazuhito Obata, Ibaraki (JP); Masaki Takeuchi, Ibaraki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/597,197

(22) PCT Filed: Apr. 24, 2008
(86) PCT No.: PCT/JP2008/057909

§ 371 Date: Apr. 13, 2010

(30) Foreign Application Priority Data
Apr. 25, 2007 (JP) 2007-115470
Sep. 25, 2007 (JP) 2007-247785

(51) Int. Cl. C09J 7/02; B32B 15/08

(52) U.S. Cl. 428/337; 428/343; 428/344; 428/339

(57) ABSTRACT

An adhesive sheet comprising a base 3 and an adhesive resin layer 4 formed on one side of the base 3, wherein the adhesive resin layer 4 has a glass transition temperature of 170-200° C. and a post-curing elastic modulus of 100-500 MPa.

### TECHNICAL FIELD

The present invention relates to an adhesive sheet.

### BACKGROUND ART

With increasingly smaller sizes, higher densities and lighter weights of electronic devices in recent years, the flexible printed circuit boards and rigid circuit boards used therein are being employed more frequently, and in large part in module boards for cellular phones.

Generally known types of flexible printed circuit boards include bilayer CCL types having a polyimide precursor directly coated onto a copper foil and condensed at high temperature (see Patent document 1, for example), trilayer CCL types having a copper foil and polyimide film attached together via a polyimide-based adhesive or other adhesive, and metallizing types having a copper layer deposited by sputtering or plating on a polyimide resin film.

Bilayer CCL types, while having excellent heat resistance, are usually expensive because they require heating steps at high temperature for prolonged periods.

Trilayer CCL types are associated with poor productivity because they require bonding steps at high-temperature and high-pressure for prolonged periods during attachment when polyimide-based adhesives are used, and while they are generally cheaper than bilayer CCL types when other adhesives are used, the heat resistance is reduced.

Metallizing types are costly for copper layer formation, and it is difficult to achieve thick copper foils. They are also disadvantageous because the cohesive strength between copper and insulating layers is poor and therefore the cohesion reliability is inferior. However, their advantages are excellent heat resistance and effective high micronization due to the thin conductive layers formed on the polyimide film bases.

Such flexible printed circuit boards are used for various purposes according to their individual characteristics, but in most cases they are used solely for the connecting sections of modules.

On the other hand, commonly employed rigid circuit boards having epoxy resins impregnated in glass cloths are made from inexpensive materials and can be bonded at relatively low temperature, while they are also suitable for multilayering, but bending of rigid circuit boards after layering and curing is difficult. Moreover, prepregs in the B-stage state, resin-attached copper foils and adhesive films, which are used to form multilayer wiring boards comprising rigid circuit boards, undergo reduction in resin flow volume when stored in ordinary-temperature atmospheres, thus resulting in problems of reduced moldability and adhesion. Therefore, these materials have been problematic for storage since they require cold storage in order to maintain their moldability and adhesion.

A flexible rigid circuit board is a form of multilayer wiring board employing a flexible circuit board and a rigid circuit board. This type of board employs a hard rigid board comprising an epoxy resin or the like impregnated in a glass cloth as mentioned above in the multilayer sections and the aforementioned flexible circuit board at the connecting sections, thus allowing both multilayering and bending to be accomplished.

[Patent document 1] Japanese Unexamined Patent Publication HEI No. 03-104185

### DISCLOSURE OF THE INVENTION

### Problems to be Solved by the Invention

Because flexible rigid circuit boards use ordinary rigid circuit boards at the multilayer sections, they have been limited in terms of their suitability for thickness reduction of the boards as a whole, even though they are effective for increasing density. In addition, because the steps for bonding flexible circuit board sections and rigid circuit board sections are complicated, such boards are associated with problems of production efficiency and cost.

A demand therefore exists for multilayering of flexible circuit boards suitable for thickness reduction without their combination with rigid circuit boards. However, multilayering of flexible circuit boards by adhesion is generally carried out using adhesives with Tg values of 100-160° C., and therefore the heat resistance of the flexible circuit boards cannot be sufficiently utilized. In addition, using an adhesive with a Tg of 160° C. or above results in insufficient cohesion between the flexible circuit board and adhesive, or an increased lamination temperature.

Therefore, adhesive sheets with excellent bendability, heat resistance and adhesion, as well as superior circuit embedding properties, are desired in order to ameliorate the problems described above.

It is an object of the present invention, which has been accomplished in light of the aforementioned problems of the prior art, to provide an adhesive sheet for use in the manufacture of multilayer wiring boards comprising multilayered flexible circuit boards, which has excellent bendability, heat resistance, adhesion and circuit embedding properties.

### Means for Solving the Problems

In order to achieve the object stated above, the invention provides an adhesive sheet comprising a base and an adhesive resin layer formed on one side of the base, wherein the adhesive resin layer is a layer with a glass transition temperature of 170-200° C. and a post-curing elastic modulus is 100-500 MPa.

With such an adhesive sheet and an adhesive resin-attached metal foil, a construction comprising an adhesive resin layer with a glass transition temperature and post-curing elastic modulus in the ranges specified above can be used for manufacture of multilayer wiring boards with multilayered flexible circuit boards, to obtain high levels of bendability, heat resistance, adhesion and circuit embedding properties. Furthermore, using an adhesive sheet according to the invention allows thin multilayer wiring boards to be obtained, with excellent moldability as well.

An adhesive sheet according to the invention preferably comprises an epoxy resin in the adhesive resin layer, and preferably the epoxy resin content is 15-40 mass % based on the total solid mass of the adhesive resin layer. If the adhesive resin layer contains the epoxy resin in this specified proportion, it will be possible to further improve the bendability, heat resistance, adhesion and circuit embedding property, while also sufficiently inhibiting run-off of the resin of the adhesive resin layer during multilayering and simplifying adjustment of the thickness of the obtained multilayer wiring board.

The adhesive sheet of the invention preferably comprises at least one type of resin selected from the group consisting of polyamide resins, polyimide resins, polyamideimide resins and polyurethane resins in the adhesive resin layer. In particular, the adhesive sheet of the invention preferably contains a siloxane-modified polyamideimide resin in the adhesive resin layer, and the siloxane modification rate of the siloxane-modified polyamideimide resin is preferably 25-45 mass %. The bendability, heat resistance, adhesion and circuit embedding property can be improved if the adhesive resin layer contains the aforementioned specified resin, and especially the aforementioned specific siloxane-modified polyamideimide resin.

The base in the adhesive sheet of the invention preferably includes a metal layer. The metal layer is preferably a copper layer with a thickness of 0.5-25 μm. If a base with such a metal layer is used, the metal layer can be utilized as a wiring material, thus allowing the adhesive sheet to be more suitable for use in the manufacture of multilayer wiring boards.

The base in the adhesive sheet of the invention is preferably a polyethylene terephthalate film with a thickness of 5-200 μm. If a polyethylene terephthalate film is used as the base, a circuit-formed flexible circuit board can be bonded after temporary anchoring of the adhesive sheet on the flexible circuit board, thus allowing increased freedom of design for the multilayer board configuration, and therefore greater suitability for manufacture of multilayer wiring boards. When an adhesive sheet having a polyethylene terephthalate film as the base is used to form a multilayer wiring board, the base is released and circuit boards are bonded together by the adhesive resin layer.

The thickness of the adhesive resin layer in the adhesive sheet of the invention is preferably no greater than 100 μm. This will help minimize the amount of exuded resin during multilayering, thus also contributing to a smaller thickness of the multilayer wiring board.

The adhesive sheet of the invention preferably has a total thickness of no greater than 100 μm for the base and the adhesive resin layer. This will result in satisfactory bendability while also contributing to a smaller thickness of the multilayer wiring board.

### EFFECT OF THE INVENTION

According to the invention it is possible to provide an adhesive sheet for use in the manufacture of multilayer wiring boards comprising multilayered flexible circuit boards, which has excellent bendability, heat resistance, adhesion and circuit embedding properties.

### BRIEF DESCRIPTION OF THE DRAWINGS

FIG. 1 is a schematic cross-sectional view showing a preferred embodiment of an adhesive sheet of the invention.

FIG. 2 is a schematic cross-sectional view showing another preferred embodiment of an adhesive sheet of the invention.

FIG. 3 is a schematic cross-sectional view showing a preferred embodiment of a multilayer wiring board (4-layer board) employing an adhesive sheet of the invention.

### EXPLANATION OF SYMBOLS

1: Electric conductor layer, 2: resin layer, 3: base, 4: adhesive resin layer, 5: separator, 6: wiring member, 7: flexible printed circuit board, 8: cured layer, 10,20: adhesive sheet, 100: multilayer wiring board.

### BEST MODE FOR CARRYING OUT THE INVENTION

Preferred embodiments of the invention will now be explained in detail, with reference to the accompanying drawings as necessary. Identical or corresponding parts in the drawings will be referred to by like reference numerals and will be explained only once.

The adhesive sheet of the invention comprises a base and an adhesive resin layer formed on one side of the base, wherein the glass transition temperature (Tg) of the adhesive resin layer is 170-200° C. and the post-curing elastic modulus of the adhesive resin layer is 100-500 MPa.

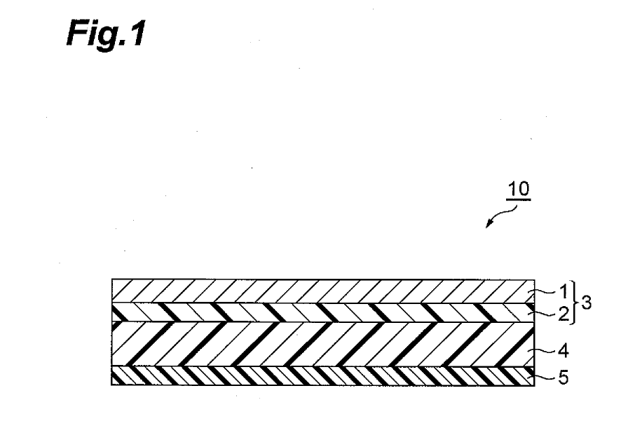

FIG. 1 is a schematic cross-sectional view showing a preferred embodiment of an adhesive sheet of the invention. The adhesive sheet 10 shown in FIG. 1 is provided with a base 3 composed of an electric conductor layer 1 and a resin layer 2, an adhesive resin layer 4 formed on one side of the base 3, and a separator 5 formed on the side of the adhesive resin layer 4 opposite the base 3.

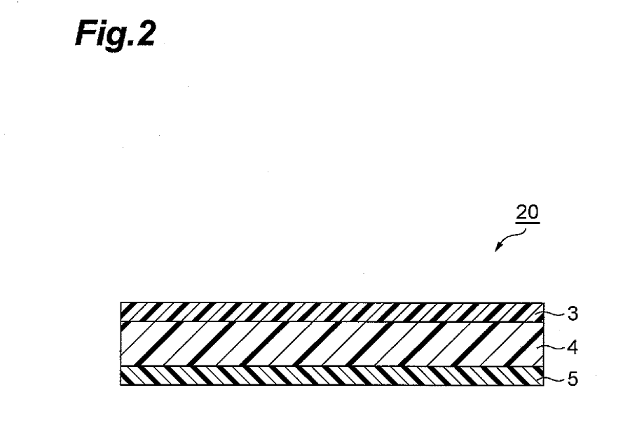

FIG. 2 is a schematic cross-sectional view showing another preferred embodiment of an adhesive sheet of the invention. The adhesive sheet 20 shown in FIG. 2 is provided with a base 3 composed of a plastic film, an adhesive resin layer 4 formed on one side of the base 3, and a separator 5 formed on the side of the adhesive resin layer 4 opposite the base 3.

In the adhesive sheets 10 and 20 shown in FIG. 1 and FIG. 2, the adhesive resin layer 4 is a layer with a glass transition temperature of 170-200° C. and a post-curing elastic modulus of 100-500 MPa. Each of the layers composing the adhesive sheets 10 and 20 will now be explained in detail.

The adhesive resin layer 4 is not particularly restricted so long as it satisfies the aforementioned conditions for the glass transition temperature and post-curing elastic modulus, but it preferably contains an epoxy resin and also preferably contains another resin component other than an epoxy resin.

As resin components other than epoxy resins, there are preferred polyamide resins, polyimide resins, polyamideimide resins and polyurethane resins, with polyamideimide resins being more preferred and siloxane-modified polyamideimide resins being especially preferred.

A siloxane-modified polyamideimide resin used in the adhesive resin layer 4 preferably has a functional group at the ends, which is at least one group selected from the group consisting of carboxyl, amino, acid anhydride and mercapto groups. The presence of such functional groups will help to further improve the heat resistance of the adhesive resin layer 4. The siloxane modification rate of the siloxane-modified polyamideimide resin is preferably 25-45 mass % and more preferably 35-45 mass %. A siloxane modification rate of less than 25 mass % will tend to result in insufficient volatilization of the solvent in the drying step during formation of the adhesive resin layer 4, tending to increase the adhesion on the surface of the adhesive resin layer 4. A siloxane modification rate of greater than 45 mass % will result in variation in the amount of volatilization of the solvent in the drying step during formation of the adhesive resin layer 4, tending to prevent stable properties from being obtained.

The glass transition temperature of the siloxane-modified polyamideimide resin is preferably 200-300° C. and more preferably 210-230° C. Using a siloxane-modified polyamideimide resin with a glass transition temperature in the range specified above will contribute to improved heat resistance, while also facilitating adjustment of the glass transition temperature of the adhesive resin layer 4 within the range of 170-200° C. and helping to improve the adhesion and inhibit run-off of the resin during pressure bonding.

The siloxane-modified polyamideimide resin content in the adhesive resin layer 4 is preferably 35-85 mass % and more preferably 45-70 mass % based on the total solid mass of the adhesive resin layer 4. A content of less than 35 mass % will tend to result in a hard adhesive resin layer 4 and poor bendability, while a content of greater than 85 mass % will result in an excessively soft adhesive resin layer 4, making it difficult to obtain the prescribed thickness during molding.

The epoxy resin used in the adhesive resin layer 4 is preferably a polyfunctional epoxy compound with two or more epoxy groups. As examples of polyfunctional epoxy compounds there may be mentioned polyglycidyl ethers obtained by reacting epichlorohydrin with a polyhydric phenol such as bisphenol A, novolac-type phenol resin or orthocresol-novolac-type phenol resin or a polyhydric alcohol such as 1,4-butanediol, polyglycidyl esters obtained by reacting epichlorohydrin with a polybasic acid such as phthalic acid or hexahydrophthalic acid, N-glycidyl derivatives of compounds with amine, amide or heterocyclic nitrogenous bases, and alicyclic epoxy resins and biphenyl-type epoxy resins. Alicyclic epoxy resins such as dicyclopentadiene-type epoxy resins are particularly preferred among the above. Such epoxy resins may be used alone or in combinations of two or more.

The epoxy resin content in the adhesive resin layer 4 is preferably 15-40 mass % and more preferably 25-40 mass % based on the total solid mass of the adhesive resin layer 4. If the content is less than 15 mass %, the elastic modulus of the cured adhesive resin layer 4 may fall to below 100 MPa, potentially causing run-off of the resin during pressure bonding with a press and making it difficult to obtain the prescribed board thickness. If the content is greater than 40 mass %, the elastic modulus of the cured adhesive resin layer 4 may rise above 500 MPa, causing the cured resin to be too hard, despite improved heat resistance, and potentially resulting in cracks during bending.

When an epoxy resin is used as the structural material for the adhesive resin layer 4, an epoxy resin curing agent, curing accelerator or the like may also be used. A curing agent and curing accelerator may be used without any particular restrictions so long as they react with the epoxy resin and accelerate its curing.

Examples of curing agents that may be used include amines, imidazoles, polyfunctional phenols and acid anhydrides. As examples of amines there may be mentioned dicyandiamide, diaminodiphenylmethane and guanylurea. As examples of polyfunctional phenols there may be mentioned hydroquinone, resorcinol, bisphenol A and their halogenated forms, as well as novolac-type phenol resins and resol-type phenol resins that are condensates with formaldehyde. As examples of acid anhydrides there may be mentioned phthalic anhydride, benzophenonetetracarboxylic dianhydride and methylhimic acid.

Examples of curing accelerators that may be used include imidazoles, such as alkyl group-containing imidazoles, benzoimidazoles and the like.

The glass transition temperature of the adhesive resin layer 4 must be 170-200° C., and is more preferably 180-200° C. A glass transition temperature of below 170° C. will result in run-off of the resin during pressure bonding with a press, making it impossible to obtain the prescribed board thickness for the wiring board. A glass transition temperature of above 200° C. may cause formation of voids during lamination with a laminator or press, resulting in inadequate adhesion. The glass transition temperature of the adhesive resin layer 4 can be adjusted by the siloxane modification rate of the siloxane-modified polyamideimide and the epoxy resin content.

The post-curing elastic modulus of the adhesive resin layer 4 must be 100-500 MPa, and is more preferably 300-500 MPa. The post-curing elastic modulus is the elastic modulus after complete curing of the curable resin in the adhesive resin layer 4. The curing conditions will differ depending on the type of resin and curing agent used, but when an epoxy resin and its curing agent are used, complete curing can be accomplished by heat treatment at 240° C. for 1 hour. If the post-curing elastic modulus is less than 100 MPa, the circuit board strength will be insufficient and a multilayer wiring board will not be easily formed. If the post-curing elastic modulus exceeds 500 MPa, the circuit board will be hard and cracking will occur with bending even at low curvature. The post-curing elastic modulus of the adhesive resin layer 4 may be adjusted by, for example, changing the mixing ratio of the siloxane-modified polyamideimide and the thermosetting component, such as an epoxy resin.

The adhesive resin layer 4 may be formed, for example, by dissolving or dispersing the siloxane-modified polyamideimide resin, epoxy resin and other components in a solvent to produce an adhesive varnish, and coating the adhesive varnish onto the base 3. As examples of solvents to be used, there may be mentioned N-methyl-2-pyrrolidone (NMP), N,N-dimethylformamide (DMF), N,N-dimethylformamide (DMAC), dimethyl sulfoxide (DMSO), dimethyl sulfate, sulfolane, cresol, phenol, halogenated phenols, cyclohexane and dioxane. The solvent used for synthesis of the siloxane-modified polyamideimide resin is preferably also used as the solvent for the adhesive varnish.

The curing rate for coating of the adhesive resin layer 4 is preferably in the range of 10-80%. A curing rate of less than 10% will increase the flow volume of the resin by the heat of circuit board lamination, tending to interfere with thickness control. A curing rate of greater than 80% will result in insufficient flow volume during lamination, thus notably lowering cohesion between the circuit-formed circuit board and adhesive resin layer 4 while also tending to cause bending or cracking of the adhesive resin layer 4 during lamination, thereby reducing workability.

The thickness of the adhesive resin layer 4 is preferably no greater than 100 μm and more preferably 10-100 μm.

The base 3 is not particularly restricted, and various plastic films, polyimide films, metals, organic materials or their composites may be appropriately selected for use according to the purpose. In the adhesive sheet 10 shown in FIG. 1, the base 3 is composed of an electric conductor layer 1 and resin layer 2, while in the adhesive sheet 20 shown in FIG. 2 the base 3 is composed of a plastic film.

The base 3 preferably comprises an electric conductor layer 1 and resin layer 2, as shown in FIG. 1. As a specific example of a base 3 comprising an electric conductor layer 1 and resin layer 2, there may be mentioned the heat-resistant adhesive film MCF-5000I (trade name) by Hitachi Chemical Co., Ltd., obtained by curing a polyimide resin by direct coating on an electric conductor layer. Using such a base can yield a multilayering circuit board material which is soft and has excellent heat resistance, workability and electrical characteristics.

The electric conductor layer 1 is not particularly restricted so long as it is a conductive layer, and a metal, organic material or composite thereof may be selected as appropriate, although the layer is preferably composed of a metal. Copper is generally used as a circuit board material, and a layer composed of copper is preferred as the electric conductor layer 1 for the present invention. The thickness of the electric conductor layer 1 may be selected within a range of 3-75 μm, according to the purpose. An electrolytic copper foil or rolled copper foil may be used as the electric conductor layer 1 for a thickness of 8 μm or greater.

There are no particular restrictions on the resin layer 2, but it is preferably a polyimide layer such as used in MCF-50001 mentioned above. The thickness of the polyimide layer is preferably 0.5 μm or greater. A thickness of less than 0.5 μm may result in reduced heat resistance after etching removal of the electric conductor layer 1.

When the base 3 is composed of a plastic film as shown in FIG. 2, the plastic film may be a polyethylene terephthalate (PET) film, polyethylene film, polyethylene naphthalate film, polypropylene film or the like. A polyethylene terephthalate (PET) film is preferred among those mentioned above.

The surface of the base 3 on which the adhesive resin layer 4 is to be formed may be surface treated as necessary, in order to improve the wettability of the adhesive resin layer 4, and especially the wettability of the adhesive varnish when the adhesive varnish is coated onto the base 3 to form the adhesive resin layer 4, and in order to prevent impairment of the outer appearance due to cissing or irregularities, or to improve cohesion and increase stability. As examples of surface treatment methods there may be mentioned UV irradiation, corona discharge treatment, buffing, sand blast, various types of dry etching, various types of wet etching, and the like. Dry etching methods using oxygen plasma treatment are preferred among these methods, for ease of continuous treatment, stability of the treatment effect, and degree of effect.

The separator 5 serves to protect the adhesive resin layer 4, and it may be formed on the side of the adhesive resin layer 4 opposite the base 3, as necessary. There are no particular restrictions on the separator 5, and for example, a plastic film such as the aforementioned polyethylene terephthalate film may be used.

The total thickness of the base 3 and adhesive resin layer 4 in the adhesive sheet 10 or 20 is preferably no greater than 100 μm and more preferably 10-60 μm.

Preferred embodiments of the adhesive sheet of the invention were explained in detail above with reference to FIG. 1 and FIG. 2, but the adhesive sheet of the invention is not limited to these embodiments. For example, the adhesive sheets 10 and 20 shown in FIG. 1 and FIG. 2 may be formed without the separator 5. Also, the base 3 may have a construction other than that shown in FIG. 1 or FIG. 2. The adhesive sheet may also have another layer in addition to the base 3, adhesive resin layer 4 and separator 5. The adhesive sheet is not limited to a sheet form, and it may instead be wound into a roll and provided for continuous machining and attachment.

When an adhesive sheet according to the invention is used for lamination of a circuit board, the lamination method is not particularly restricted and may be, for example, press lamination, continuous lamination with a heated roll, or the like. It is preferred for the lamination to be carried out with a hot press in a vacuum, for uniform attachment of the adhesive resin layer 4 in an efficient manner on one or both sides of an adherend while avoiding variation in the properties, to form the multilayer wiring board.

The separator 5 is released when the adhesive sheet 10 shown in FIG. 1 is used, but the base 3 may be used directly as a wiring material without release, and if necessary a circuit may be formed in the metal layer 1. The adhesive sheet 20 shown in FIG. 2, on the other hand, requires release of both the separator 5 and base 3.

For continuous lamination with a heated roll, the method of curing the adhesive resin layer 4 may be any method such as thermosetting, ultraviolet curing, electron beam curing or the like. These curing methods are not particularly restricted so long as sufficient energy can be supplied for curing reaction of the adhesive resin layer 4, but continuous curing by thermosetting is preferred, and a method involving continuous lamination with a heated roll, lateral transport to a continuous thermosetting furnace and post-curing wind-up is preferred from the viewpoint of preventing wrinkles and folds due to cure shrinkage of the adhesive resin layer 4 after curing. In this case, the curing and wind-up may be followed by post-heat treatment for a prescribed period of time for more stable quality.

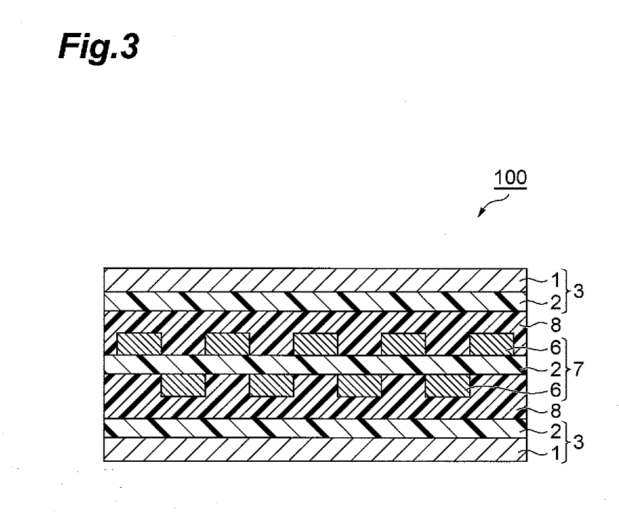

FIG. 3 is a schematic cross-sectional view showing a preferred embodiment of a multilayer wiring board (4-layer board) formed using the adhesive sheet 10 shown in FIG. 1. As shown in FIG. 3, the multilayer wiring board 100 has a structure with bases 3, each comprising an electric conductor layer 1 and a resin layer 2, bonded onto both sides of a flexible printed circuit board 7 comprising a resin layer 2 and conductive wiring members 6 formed on both sides thereof, via cured layers 8 obtained by curing the adhesive resin layer 4. In the multilayer wiring board 100, the electric conductor layer 1 of each base 3 is used as a wiring member, allowing formation of a 4-layer wiring pattern. The structural material of each wiring member 6 may be the same material as the electric conductor layer 1.

Because the multilayer wiring board 100 is formed using an adhesive sheet according to the invention as described above, it has excellent heat resistance, dimensional stability, bonding reliability, workability, flexural properties and handleability.

### EXAMPLES

The present invention will now be explained in greater detail based on examples and comparative examples, with the understanding that the invention is in no way limited to the examples.

### Example 1

### (1) Preparation of Adhesive Resin Layer-Forming Varnish

An adhesive resin layer-forming varnish was prepared by mixing 70 parts by mass of a siloxane-modified polyamideimide resin (trade name: KT10-TMA, product of Hitachi Chemical Co., Ltd.) with a Tg of 200° C. and prepared to a siloxane modification rate of 35 mass %, 21 parts by mass of a biphenyl-type epoxy resin (trade name: YX4000, product of Japan Epoxy Resins Co., Ltd.), 9 parts by mass of a curing agent (trade name: KA-1165, product of Dainippon Ink and Chemicals, Inc.) and 0.35 part by mass of a curing accelerator (trade name: 2-ethyl-4-methylimidazole, product of Shikoku Chemicals Corp.).

### (2) Formation of Adhesive Resin Layer

A coating machine was used to coat the adhesive resin layer-forming varnish prepared in (1) onto the polyimide layer of a base composed of a polyimide layer and a copper foil layer formed on one side thereof (MCF-5000I (trade name) single-sided board, product of Hitachi Chemical Co., Ltd., copper foil layer thickness: 35 μm, polyimide layer thickness: 25 μm), and it was dried with a drying furnace at 150° C. at a line speed of 0.5 m/min. This produced an adhesive sheet comprising an adhesive resin layer with a post-drying thickness of 50 μm. The obtained adhesive sheet had an adhesive resin layer with a Tg of 185° C., and the cured layer obtained by curing with heat treatment of the adhesive resin layer at 240° C. for 1 hour had an elastic modulus of 300 MPa.

### (3) Fabrication of Copper-Clad Laminate

A 100 t vacuum press machine was used for hot pressing of the adhesive sheet formed in (2) above onto both sides of a base having a circuit-formed copper foil layer formed on both sides of a polyimide layer (MCF-5000I (trade name) double-sided sheet, product of Hitachi Chemical Co., Ltd., copper foil layer thickness: 35 μm, polyimide layer thickness: 30 μm), at 240° C., 4 MPa for 40 minutes for bonding, to obtain a multilayer wiring board (4-layer board) having the structure shown in FIG. 3.

### Example 2

An adhesive sheet was fabricated in the same manner as Example 1, except that the structure for the thickness of the MCF-5000I single-sided board for coating of the adhesive resin layer-forming varnish prepared in Example 1 was changed to be a copper foil layer thickness of 9 μm and a polyimide layer thickness of 6 μm. A 100 t vacuum press machine was used for hot pressing of the fabricated adhesive sheet onto both sides of a base having a circuit-formed copper foil layer formed on both sides of a polyimide layer (MCF-50001 (trade name) double-sided sheet, product of Hitachi Chemical Co., Ltd., copper foil layer thickness: 9 μm, polyimide layer thickness: 9 μm), at 240° C., 4 MPa for 40 minutes for bonding, to obtain a multilayer wiring board (4-layer board) having the structure shown in FIG. 3.

### Example 3

An adhesive resin layer-forming varnish was prepared in the same manner as Example 1. A coating machine was used to coat the adhesive resin layer-forming varnish onto a silicone release treated PET film (trade name: PUREX A31-75 by Teijin, Ltd., thickness: 125 μm) as the base, and the varnish was dried with a drying furnace at 150° C. at a line speed of 0.5 m/min. This produced an adhesive sheet comprising an adhesive resin layer with a post-drying thickness of 50 μm.

The base (PUREX A31-75) was released from the obtained adhesive sheet and the adhesive resin layer was situated on both sides of a base having a circuit-formed copper foil layer formed on both sides of a polyimide layer (MCF-5000I (trade name) double-sided sheet, product of Hitachi Chemical Co., Ltd., copper foil layer thickness: 9 μm, polyimide layer thickness: 9 μm), while an electrolytic copper foil (trade name: F2WS9 μm) by Furukawa Circuit Foil Co., Ltd. was further situated on both sides thereof, and a 100 t vacuum press machine was used for hot pressing at 240° C., 4 MPa for 40 minutes for bonding, to obtain a multilayer wiring board (4-layer board).

### Example 4

An adhesive sheet and multilayer wiring board (4-layer board) were fabricated in the same manner as Example 1, except that a siloxane-modified polyamideimide resin (trade name: KT10-TMA by Hitachi Chemical Co., Ltd.) with a Tg of 200° C. and a siloxane modification rate of 23 mass % was used instead of a siloxane-modified polyamideimide resin with a Tg of 200° C. and a siloxane modification rate of 35 mass %. The obtained adhesive sheet had an adhesive resin layer with a Tg of 185° C., and the cured layer obtained by curing with heat treatment of the adhesive resin layer at 240° C. for 1 hour had an elastic modulus of 300 MPa.

### Example 5

An adhesive sheet and multilayer wiring board (4-layer board) were fabricated in the same manner as Example 1, except that a siloxane-modified polyamideimide resin (trade name: KT10-TMA by Hitachi Chemical Co., Ltd.) with a Tg of 200° C. and a siloxane modification rate of 47 mass % was used instead of a siloxane-modified polyamideimide resin with a Tg of 200° C. and a siloxane modification rate of 35 mass %. The obtained adhesive sheet had an adhesive resin layer with a Tg of 185° C., and the cured layer obtained by curing with heat treatment of the adhesive resin layer at 240° C. for 1 hour had an elastic modulus of 300 MPa.

### Comparative Example 1

An adhesive sheet and multilayer wiring board (4-layer board) were fabricated in the same manner as Example 1, except that a siloxane-modified polyamideimide resin (trade name: KT10-TMA by Hitachi Chemical Co., Ltd.) with a Tg of 180° C. and a siloxane modification rate of 35 mass % was used instead of a siloxane-modified polyamideimide resin with a Tg of 200° C. and a siloxane modification rate of 35 mass %. The obtained adhesive sheet had an adhesive resin layer with a Tg of 160° C., and the cured layer obtained by curing with heat treatment of the adhesive resin layer at 240° C. for 1 hour had an elastic modulus of 275 MPa.

### Comparative Example 2

An adhesive sheet and multilayer wiring board (4-layer board) were fabricated in the same manner as Example 1, except that a siloxane-modified polyamideimide resin (trade name: KT10-TMA by Hitachi Chemical Co., Ltd.) with a Tg of 225° C. and a siloxane modification rate of 35 mass % was used instead of a siloxane-modified polyamideimide resin with a Tg of 200° C. and a siloxane modification rate of 35 mass %. The obtained adhesive sheet had an adhesive resin layer with a Tg of 210° C., and the cured layer obtained by curing with heat treatment of the adhesive resin layer at 240° C. for 1 hour had an elastic modulus of 340 MPa.

### Comparative Example 3

An adhesive resin layer-forming varnish was prepared by mixing 85 parts by mass of a siloxane-modified polyamideimide resin (trade name: KT10-TMA, product of Hitachi Chemical Co., Ltd.) with a Tg of 185° C. and prepared to a siloxane modification rate of 35 mass %, 11 parts by mass of a biphenyl-type epoxy resin (trade name: YX4000, product of Japan Epoxy Resins Co., Ltd.), 4 parts by mass of a curing agent (trade name: KA-1165, product of Dainippon Ink and Chemicals, Inc.) and 0.35 part by mass of a curing accelerator (trade name: 2-ethyl-4-methylimidazole, product of Shikoku Chemicals Corp.). An adhesive sheet and multilayer wiring board (4-layer board) were fabricated in the same manner as Example 1 except for using this adhesive resin layer-forming varnish. The obtained adhesive sheet had an adhesive resin layer with a Tg of 180° C., and the cured layer obtained by curing with heat treatment of the adhesive resin layer at 240° C. for 1 hour had an elastic modulus of 50 MPa.

### Comparative Example 4

An adhesive resin layer-forming varnish was prepared by mixing 35 parts by mass of a siloxane-modified polyamideimide resin (trade name: KT10-TMA, product of Hitachi Chemical Co., Ltd.) with a Tg of 185° C. and prepared to a siloxane modification rate of 35 mass %, 45 parts by mass of a biphenyl-type epoxy resin (trade name: YX4000, product of Japan Epoxy Resins Co., Ltd.), 20 parts by mass of a curing agent (trade name: KA-1165, product of Dainippon Ink and Chemicals, Inc.) and 0.35 part by mass of a curing accelerator (trade name: 2-ethyl-4-methylimidazole, product of Shikoku Chemicals Corp.). An adhesive sheet and multilayer wiring board (4-layer board) were fabricated in the same manner as Example 1 except for using this adhesive resin layer-forming varnish. The obtained adhesive sheet had an adhesive resin layer with a Tg of 170° C., and the cured layer obtained by curing with heat treatment of the adhesive resin layer at 240° C. for 1 hour had an elastic modulus of 650 MPa.

(Evaluation of Base Outer Appearance)

The outer layer copper foils of the four-layer boards obtained in the examples and comparative examples were subjected to etching and the outer appearances of the boards were visually observed. Satisfactory embedding of inner layer circuits was judged as OK, while generation of inner layer voids, over-running of the resin and notably irregularities in the circuit were judged as NG. The results are shown in Tables 1 and 2.

(Measurement of Copper Foil Adhesion)

Sandpaper was used to polish the boards from one side of the 4-layer boards obtained in the examples and comparative examples, and after exposing the inner layer copper foil of the second layer, the copper foil was partially etched to form a copper foil line with a 1 mm width. The copper foil line was peeled off at a speed of 50 mm/min in the 90° direction with respect to the bonding surface, and the load at that time was measured, recording the maximum load as the peel strength (copper foil adhesion). The results are shown in Tables 1 and 2.

(Evaluation of Solder Heat Resistance)

The 4-layer boards of the examples and comparative examples were cut into a square with 50 mm sides, to obtain a test piece. The test piece was immersed in a solder bath at 288° C., and the time from that point until the test piece visibly swelled was measured. The results are shown in Tables 1 and 2. The listing of “≧5 minutes” in the table means that no swelling occurred even after 5 minutes.

(Evaluation of Pressure-Sensitive Adhesive Property)

The pressure-sensitive adhesive property was evaluated by a probe tack test with the adhesive resin layers of the adhesive sheets obtained in the examples and comparative examples. Specifically, a 40° C. heated probe was plunged into the adhesive resin layer of the adhesive sheet placed on a stage heated to 40° C., and then the maximum load when pulling it out was measured, with the pressure-sensitive adhesive property being recorded as the average value of 5 measured points. The probe diameter was 5 mm, the probe speed was 30 mm/min, the probe plunging load was 100 gf and the probe contact time was 2 seconds. The measuring apparatus used was a probe tack tester (Tack Tester by Rhesca Corp.), according to JISZ0237-1991. The results are shown in Tables 1 and 2. Example 5 had large variation in the measured values, with a minimum of 5 g and a maximum of 24 g for the measured values of the pressure-sensitive adhesive property at 5 points.

(Evaluation of Exuded Resin Volume)

Upon fabrication of the 4-layer boards of the examples and comparative examples, the exuded resin volume at the center section from the 4 sides of the pressed base was measured using a metal ruler with a measuring scale of 0.5 mm, and the average value of 4 points was recorded as the exuded volume. The results are shown in Tables 1 and 2. Example 5 had large variation in the measured values, with a minimum of 3 mm and a maximum of 7 mm for the measured values of the exuded volume at 4 points.

(Evaluation of Bendability)

A test piece of 10 mm width×100 mm length was cut out from the circuit board that had been etched across the entire surface of the copper foil on both sides of each 4-layer board obtained in the examples and comparative examples. The test piece was placed on a stage and folded over and sandwiching a pin having a diameter (R) of 0.10 mm, 0.25 mm or 0.50 mm. A roller was rolled back and forth over the section of the test piece sandwiching the pin, and the presence of any cracks in the cured adhesive resin layer was observed in the locally folded portion of the test piece. The evaluation was conducted using the scale shown below. A smaller number of cracks (whitening) corresponds to higher bendability (flexibility). The results are shown in Tables 1 and 2.

A: No abnormalities
B: Partial whitening due to cracks
C: Whitening throughout due to cracks

(Evaluation of Circuit Embedding Property)

The 4-layer boards obtained in the examples and comparative examples were cut and were cast with an epoxy resin and the cut surfaces were polished with water-resistant paper to prepare test pieces. The filled condition of the adhesive resin near the inner layer copper foil on the cut surface was observed with an optical microscope. A condition with the adhesive resin completely filling the area surrounding the inner layer copper foil was judged as satisfactory, while a condition with any apparent voids surrounding the copper foil was judged as unsatisfactory. The results are shown in Tables 1 and 2.

(Measurement of Dimensional Change Rate)

Each of the 4-layer boards obtained in the examples and comparative examples was cut into a 250 mm square, and 0.5 mm drill holes were opened at positions 10 mm from each of the 4 corners toward the center. Using the drill holes as evaluation points, the distance between the evaluation points as the machine direction (MD) of the copper foil and the direction crossing at 90 degrees to the machine direction as the transverse direction (TD), measurement was conducted with a three-dimensional measuring machine at a minimum scale of 1 μm. The copper foils on both sides of the test piece were then removed by etching, and after air drying for 24 hours, the distance between the evaluation points was again measured with the three-dimensional measuring machine, and the dimensional change rate (%) was determined by the following formula:

Dimensional change rate (%)={(distance between evaluation points after removal of copper foil−distance between evaluation points before removal of copper foil)/distance between evaluation points before removal of copper foil}×100. The results are shown in Tables 1 and 2. Measurement could not be performed in Comparative Example 3 because of significant run-off of the resin, swelling and irregularities on the surface, and failure of the test piece to smoothly attach to the measuring machine.

TABLE 1

| | | Example 1 | Example 2 | Example 3 | Example 4 | Example 5 |
|---|---|---|---|---|---|---|
| 4-Layer board thickness (μm) | | 250 | 104 | 135 | 250 | 250 |
| Siloxane modification rate (mass %) | | 35 | 35 | 35 | 23 | 47 |
| Epoxy resin content (parts by mass) | | 21 | 21 | 21 | 21 | 21 |
| Adhesive resin layer Tg (° C.) | | 185 | 185 | 185 | 185 | 185 |
| Elastic modulus of cured adhesive | | 300 | 300 | 300 | 300 | 300 |
| resin layer (MPa) | | | | | | |
| Base outer appearance | | OK | OK | OK | OK | OK |
| Copper foil adhesion (kN/m) | | 0.70 | 0.70 | 0.70 | 0.70 | 0.60 |
| Solder heat resistance | | ≧5 min | ≧5 min | ≧5 min | ≧5 min | 3 min |
| Pressure-sensitive | Average value | 5 | 5 | 5 | 40 | 14 |
| adhesive property | Variation | 2.5-7.5 | 2.5-7.5 | 2.5-7.5 | 30-50 | 4-24 |
| of adhesive resin | | | | | | |
| layer (g) | | | | | | |
| Resin run-off | Average value | 5 | 5 | 5 | 8 | 6 |
| volume during | Variation | 4.5-5 | 4.5-5 | 4.5-5 | 7-9 | 3-7 |
| pressing (mm) | | | | | | |
| Pin gauge bending | R = 0.1 mm | A | A | A | A | A |
| | R = 0.25 mm | A | A | A | A | A |
| | R = 0.5 mm | A | A | A | A | A |
| Circuit embedding property | | OK | OK | OK | OK | OK |
| Dimensional | MD | 0.01 | 0.01 | 0.01 | 0.01 | 0.01 |
| stability (%) | TD | 0.01 | 0.01 | 0.01 | 0.01 | 0.01 |

TABLE 2

| | | Comp. Ex. 1 | Comp. Ex. 2 | Comp. Ex. 3 | Comp. Ex. 4 |
|---|---|---|---|---|---|
| 4-Layer board thickness (μm) | | 250 | 250 | 200 | 250 |
| Siloxane modification rate (mass %) | | 35 | 35 | 35 | 35 |
| Epoxy resin content (parts by mass) | | 21 | 21 | 11 | 45 |
| Adhesive resin layer Tg (° C.) | | 160 | 210 | 180 | 170 |
| Elastic modulus of cured adhesive | | 275 | 340 | 50 | 650 |
| resin layer (MPa) | | | | | |
| Base outer appearance | | OK | OK | NG | OK |
| Copper foil adhesion (kN/m) | | 0.30 | 0.60 | 0.60 | 0.60 |
| Solder heat resistance | | 30 sec | ≧5 min | 3 min | ≧5 min |
| Pressure-sensitive | Average value | 12 | 2 | 7 | 3 |
| adhesive property | Variation | 10-14 | 1-3 | 3-10 | 2-4 |
| of adhesive resin | | | | | |
| layer (g) | | | | | |
| Resin run-off | Average value | 5 | 1.5 | 15 | 4 |
| volume during | Variation | 4.5-5 | 0.5-1.5 | 13-17 | 4-4.5 |
| pressing (mm) | | | | | |
| Pin gauge bending | R = 0.1 mm | A | A | A | C |
| | R = 0.25 mm | A | A | A | C |
| | R = 0.5 mm | A | A | A | B |
| Circuit embedding property | | OK | NG | NG | OK |
| Dimensional | MD | 0.05 | 0.01 | unmeasurable | 0.01 |
| stability (%) | TD | 0.05 | 0.01 | unmeasurable | 0.01 |

The adhesive sheets and 4-layer boards obtained in Examples 1-3 were confirmed to have excellent copper foil adhesion, circuit embedding property, heat resistance, dimensional stability and bendability. Also, while the adhesive sheet obtained in Example 4 had insufficient evaporation of the solvent in the drying step during formation of the adhesive resin layer, with a high pressure-sensitive adhesive property of the adhesive resin layer surface and thus poor handleability, the obtained 4-layer board was confirmed to have excellent copper foil adhesion, circuit embedding property, heat resistance, dimensional stability and bendability. Also, the adhesive sheet obtained in Example 5 had variation in the amount of evaporation of the solvent in the drying step during formation of the adhesive resin layer, with consequent variation in the pressure-sensitive adhesive property of the adhesive resin layer and the exuded resin volume during pressing, but the obtained 4-layer board was confirmed to have excellent copper foil adhesion, circuit embedding property, heat resistance, dimensional stability and bendability.

On the other hand, the adhesive sheet and 4-layer board obtained in Comparative Example 1 were confirmed to have inferior copper foil adhesive force and heat resistance. Also, the adhesive sheet and 4-layer board obtained in Comparative Example 2 exhibited excellent heat resistance but had an insufficient flow property of the adhesive resin layer during pressing, and were confirmed to have a poor circuit embedding property. The adhesive sheet and 4-layer board obtained in Comparative Example 3 had run-off of the resin during heat bonding by pressing for multilayering, such that the desired board thickness could not be obtained (that is, the board thickness was only 200 μm in Comparative Example 3, compared to a board thickness of 250 μm in Example 1 and other examples which employed the same type of base), and they were confirmed to be unsuitable for production of a multilayering circuit board. Furthermore, the adhesive sheet and 4-layer board obtained in Comparative Example 4 were confirmed to have microcracks in the cured adhesive resin layer, according to a pin gauge bending test.

### INDUSTRIAL APPLICABILITY

As explained above, the invention can provide an adhesive sheet for use in the manufacture of multilayer wiring boards comprising multilayered flexible circuit boards, which has excellent bendability, heat resistance, adhesion and circuit embedding properties.

1. An adhesive sheet comprising a base and an adhesive resin layer formed on one side of the base,
wherein the adhesive resin layer is a layer with a glass transition temperature of 170-200° C. and a post-curing elastic modulus of 100-500 MPa.

2. An adhesive sheet according to claim 1, which comprises an epoxy resin in the adhesive resin layer, wherein the epoxy resin content is 15-40 mass % based on the total solid mass of the adhesive resin layer.

3. An adhesive sheet according to claim 1, which comprises at least one type of resin selected from the group consisting of polyamide resins, polyimide resins, polyamideimide resins and polyurethane resins in the adhesive resin layer.

4. An adhesive sheet according to claim 1, which contains a siloxane-modified polyamideimide resin in the adhesive resin layer, wherein the siloxane modification rate of the siloxane-modified polyamideimide resin is 25-45 mass %.

5. An adhesive sheet according to claim 1, wherein the base comprises a metal layer.

6. An adhesive sheet according to claim 5, wherein the metal layer is a copper layer with a thickness of 0.5-25 μm.

7. An adhesive sheet according to claim 1, wherein the base is a polyethylene terephthalate film with a thickness of 5-200 μm.

8. An adhesive sheet according to claim 1, wherein the thickness of the adhesive resin layer is no greater than 100 μm.

9. An adhesive sheet according to claim 1, wherein the total thickness of the base and the adhesive resin layer is no greater than 100 μm.
